(19) United States
(12) Patent Application Publication
(10) Pub. No.: US 2020/0032867 A1
(43) Pub. Date: Jan. 30, 2020

(54) MATERIAL FOR BRAKE PADS, BRAKE PADS INCORPORATING THE SAME, AND METHODS OF MAKING SUCH MATERIAL AND BRAKE PADS

(71) Applicant: CWD, LLC, Carson, CA (US)

(72) Inventor: Poh Wah Lee, Anaheim, CA (US)

(21) Appl. No.: 16/044,478

(22) Filed: Jul. 24, 2018

(51) Int. Cl. F16D 69/02

(52) U.S. Cl. CPC F16D 69/026; B29C 43/18; F16D 2200/0086; F16D 2200/0043

(57) ABSTRACT

A brake pad, a mixture of materials for forming a brake pad, and a method for forming a brake pad.

### BACKGROUND OF THE INVENTION

Brake pads are typically made of materials including copper and/or steel fibers. Copper has played an important role in non-asbestos friction materials used in brake pads. Because of its hazardous environmental consequences per regulation being adopted in the states of California and Washington limiting its continued use, copper is been replaced with steel fibers. However, steel fibers tend to be more aggressive and as such brake rotors wear out a lot faster, leading to more brake dust and the brake dust generated staining of the surface of vehicle rims. Often, antimony is used as a lubricant in the friction material used in brake pads. However, it is preferred to eliminate or reduce antimony in brake pad formulations. Thus, improved materials for use in making brake pads are desired.

### SUMMARY

In an example embodiment a mixture having a volume for forming a brake pad includes at least one binder in the range of 11% to 15% by volume of the mixture, at least one type of fiber in the range of 3% to 8% by volume of the mixture, at least one lubricant in the range 7% to 13% by volume of the mixture, the at least one type of fiber free potassium titanate or fiber free modified potassium titanate in the range of 11% to 16% by volume of the mixture, at least two abrasives in the range of 13% to 17% by volume of the mixture, and at least two fillers in the range of 31% to 55% by volume of the mixture. In another example embodiment, the at least one binder is in the range of 11% to 13% by volume of the mixture, the at least one type of fiber is in the range of 6% to 8% by volume of the mixture, the at least one lubricant is in the range of 8% to 10% by volume of the mixture, the at least one type of fiber free potassium titanate or fiber free modified potassium titanate is in the range of 12% to 14% by volume of the mixture, the at least two abrasives are in the range of 13% to 15% by volume of the mixture, and the at least two fillers are in the range of 40% to 50% by volume of the mixture. In yet another example embodiment, the mixture includes 12% by volume of the at least one binder, 7.5% by volume the at least one type of fiber, 9.6% by volume the at least one lubricant, 13.5% by volume of the at least one type of fiber-free potassium titanate, 13.8% by volume of the at least two abrasives, and 43.6% by volume of the at least two fillers. In a further example embodiment, the at least one binder is a phenol aralkyl resin, the at least one fiber is an aramid fiber, and the at least one lubricant is synthetic graphite. The at least one type of fiber-free potassium titanate or fiber-free modified potassium titanate is lithium potassium titanate. The at least two abrasives include zirconium silicate, iron oxide, magnesium oxide, and aluminum oxide. The at least two fillers include, rubber, barium sulfate, mica, calcium silicate, and friction dust. In yet a further example embodiment, the zirconium silicate is 3% to 7% by volume of the mixture, the iron oxide is 1% to 3% by volume of the mixture, the magnesium oxide is 3% to 8% by volume of the mixture, the aluminum oxide is 0.1% to 1.5% by volume of the mixture, the rubber is 2% to 9% by volume of the mixture, the barium sulfate is 16% to 21% by volume of the mixture, the mica is 2% to 6% by volume of the mixture, the calcium silicate is 1% to 4% by volume of the mixture, and the friction dust 7% to 13% by volume of the mixture. In one example embodiment, the zirconium silicate is 5.3% by volume of the mixture, the iron oxide is 2.6% by volume of the mixture, the magnesium oxide is 5.7% by volume of the mixture, the aluminum oxide is 0.2% by volume of the mixture, the rubber is 4.4% by volume of the mixture, the barium sulfate is 18.2% by volume of the mixture, the mica is 5.4% by volume of the mixture, the calcium silicate is 3.1% by volume of the mixture, and the friction dust 12.4% by volume of the mixture. In another example embodiment, the at least one type of binder is an unmodified or modified phenolic resin, or a combinations thereof. The at least one type of fiber is an aramid fiber, poly-acrylonitrile (PAN) fiber, or cellulose fiber, or combinations thereof. The at least one lubricant is a metal sulfide, metal alloy, graphite, or petroleum coke, or combinations thereof. Each of the at least two abrasives is an aluminum oxide, magnesium oxide, iron oxide, sand, silicone carbide, silicon dioxide, zirconium oxide, or zirconium silicate, or combinations thereof. Each of the at least two fillers is a barium sulfate, calcium carbonate, calcium silicate, friction dust, mica, or rubber powder, or combinations thereof. In one example embodiment, the at least one type of binder is a phenol aralkyl resin, the at least one type of fiber is an aramid fiber, the at least one lubricant is synthetic graphite, the at least two abrasives are either an aluminum oxide, magnesium oxide, iron oxide, zirconium silicate, or combinations thereof, and the at least two fillers are each a barium sulfate, calcium silicate, friction dust, mica, rubber powder, or combinations thereof.

In yet another example embodiment, a method forming a brake pad includes creating any of the aforementioned example embodiment mixtures, placing the mixture in a mold, pressing the homogeneous mixture at a pressure in the range of 10 to 40 MPa and at a temperature in the range of 300° to 340° F. for a period of 5 to 10 minutes forming a solidified mixture, and heating the solidified mixture at a temperature of 430° to 470° F. forming the brake pad. In a further example embodiment, the method further includes placing a backing plate in the mold, and wherein placing the mixture includes placing the mixture on the backing plate, and where the formed brake pad is bonded to the backing plate.

In an example embodiment a brake pad includes at least one binder in the range of 11% to 15% by volume of the brake pad, at least one type of fiber in the range of 3% to 8% by volume of the brake pad, at least one lubricant in the range 7% to 13% by volume of the brake pad, the at least one type of fiber free potassium titanate or fiber free modified potassium titanate in the range of 11% to 16% by volume of the brake pad, at least two abrasives in the range of 13% to 17% by volume of the brake pad, and at least two fillers in the range of 31% to 55% by volume of the brake pad. In another example embodiment, the at least one binder is in the range of 11% to 13% by volume of the brake pad, the at least one type of fiber is in the range of 6% to 8% by volume of the brake pad, the at least one lubricant is in the range of 8% to 10% by volume of the brake pad, the at least one type of fiber free potassium titanate or fiber free modified potassium titanate is in the range of 12% to 14% by volume of the brake pad, the at least two abrasives are in the range of 13% to 15% by volume of the brake pad, and the at least two fillers are in the range of 40% to 50% by volume of the brake pad. In yet another example embodiment, the brake pad includes 12% by volume of the at least one binder, 7.5% by volume the at least one type of fiber, 9.6% by volume the at least one lubricant, 13.5% by volume of the at least one type of fiber-free potassium titanate, 13.8% by volume of the at least two abrasives, and 43.6% by volume of the at least two fillers. In a further example embodiment, the at least one binder is a phenol aralkyl resin, the at least one fiber is an aramid fiber, and the at least one lubricant is synthetic graphite. The at least one type of fiber-free potassium titanate or fiber-free modified potassium titanate is lithium potassium titanate. The at least two abrasives include zirconium silicate, iron oxide, magnesium oxide, and aluminum oxide. The at least two fillers include, rubber, barium sulfate, mica, calcium silicate, and friction dust. In yet a further example embodiment, the zirconium silicate is 3% to 7% by volume of the brake pad, the iron oxide is 1% to 3% by volume of the brake pad, the magnesium oxide is 3% to 8% by volume of the brake pad, the aluminum oxide is 0.1% to 1.5% by volume of the brake pad, the rubber is 2% to 9% by volume of the brake pad, the barium sulfate is 16% to 21% by volume of the brake pad, the mica is 2% to 6% by volume of the brake pad, the calcium silicate is 1% to 4% by volume of the brake pad, and the friction dust 7% to 13% by volume of the brake pad. In one example embodiment, the zirconium silicate is 5.3% by volume of the brake pad, the iron oxide is 2.6% by volume of the brake pad, the magnesium oxide is 5.7% by volume of the brake pad, the aluminum oxide is 0.2% by volume of the brake pad, the rubber is 4.4% by volume of the brake pad, the barium sulfate is 18.2% by volume of the brake pad, the mica is 5.4% by volume of the brake pad, the calcium silicate is 3.1% by volume of the brake pad, and the friction dust 12.4% by volume of the brake pad. In another example embodiment, the at least one type of binder is an unmodified or modified phenolic resin, or a combinations thereof. The at least one type of fiber is an aramid fiber, poly-acrylonitrile (PAN) fiber, or cellulose fiber, or combinations thereof. The at least one lubricant is a metal sulfide, metal alloy, graphite, or petroleum coke, or combinations thereof. Each of the at least two abrasives is an aluminum oxide, magnesium oxide, iron oxide, sand, silicon carbide, silicon dioxide, zirconium oxide, or zirconium silicate, or combinations thereof. Each of the at least two fillers is a barium sulfate, calcium carbonate, calcium silicate, friction dust, mica, or rubber powder, or combinations thereof. In one example embodiment, the at least one type of binder is a phenol aralkyl resin, the at least one type of fiber is an aramid fiber, the at least one lubricant is synthetic graphite, the at least two abrasives are either an aluminum oxide, magnesium oxide, iron oxide, zirconium silicate, or combinations thereof, and the at least two fillers are each a barium sulfate, calcium silicate, friction dust, mica, rubber powder, or combinations thereof.

### BRIEF DESCRIPTION OF THE DRAWING

FIG. 1 is a schematic view of the mold used to form an example embodiment brake pad.

FIG. 2 is a perspective view of an example embodiment brake pad.

### DETAILED DESCRIPTION

In an example embodiment, a brake pad material is provided that does not include copper, steel or antimony. In another example embodiment, the brake pad also does not include any metal fibers. In example embodiments, the brake pads disclosed herein are also free of copper, steel, antimony and metal fibers. The brake pad material is formed by forming a mixture that is then pressed and heated to form a brake pad. In an example embodiment, the mixture includes at least one binder. In an example embodiment, the binder materials include unmodified or modified phenolic resins, or combinations thereof. In an example embodiment a phenol aralkyl resin is used as the binder. In an example embodiment, the at least one binder forms about 11%-15% by volume of the mixture. In another example embodiment, the at least one binder forms about 11%-13% by volume of the mixture. In a further example embodiment, the at least one binder is 12% of the volume of the mixture. In an example embodiment, the at least one binder is in powder form. Also included in the mixture is at least one type of fiber. In an example embodiment, the at least one type of fiber is a type of fiber including aramid fibers, poly acrylonitrile (PAN) fibers, or cellulose fibers, or combinations thereof. In an example embodiment, the at least one type of fiber is an aramid fiber. In an example embodiment the at least one type of fiber are in the range of 3%-8%, in another example embodiment, in the range of 6%-8% of the mixture by volume and in yet another example embodiment 7.5%. The mixture also includes at least one lubricant. In an example embodiment the at least one lubricant includes metal sulfides, metal alloys, graphite, petroleum coke, or combinations thereof. In one example embodiment, the lubricant is synthetic graphite. In an example embodiment, the lubricant forms about 7%-13%, in another example embodiment, 8%-10%, and in a further example 9.6%, of the mixture by volume. In an example embodiment, the lubricant is in powder form. The mixture further includes at least a fiber-free potassium titanate and/or fiber-free modified potassium titanate in the range of 11%-16%, in another example embodiment, in the range of 11%-14%, in further example embodiment, in the range of 12%-14%, and in yet another example embodiment 13.5% of the mixture by volume. In an example embodiment, the fiber-free potassium titanate used is a lithium potassium titanate. At least two abrasives are also included in the mixture forming 13%-17%, in another example embodiment 13%-15%, and in yet a further example embodiment 13.8% of the mixture by volume. In an example embodiment, the at least two abrasives include aluminum oxides, magnesium oxides, iron oxides, sand, silicone carbides, silicone dioxides, zirconium oxides, or zirconium silicates, or combinations thereof. In an example embodiment, the at least two abrasives include zirconium silicate, iron oxide, magnesium oxide, or aluminum oxide, or combinations thereof. In an example embodiment, each of the at least two abrasives is in powder form. In an example embodiment, the at least two abrasives include 3-7% by volume zirconium silicate, 1%-3% iron oxide, 3%-8% magnesium oxide, and 0.1%-1.5% aluminum oxide. In another example embodiment, the at least two abrasives include about 5.3% by volume zirconium silicate, about 2.6% iron oxide, about 5.7% magnesium oxide, and about 0.2%% aluminum oxide. The mixture also includes at least two fillers in the range of 31%-55%, and in another example embodiment, 40%-50%, and in yet another example embodiment 43.6% of the mixture by volume. The at least two fillers include barium sulfates, calcium carbonates, calcium silicates, friction dust, mica, or rubber powders, or combinations thereof. In an example embodiment, the at least two fillers include rubber powder, barium sulfate, calcium silicate, mica, friction dust, or combinations thereof. In an example embodiment, the at least two fillers are in powder form. In one example embodiment, the at least two fillers include 2%-9% by volume rubber, 16%-21% barium sulfate, 2%-6% mica, 1%-4% calcium silicate, and 5%-13% friction dust. In another example embodiment, the at least two abrasives include about 4.4% by volume rubber, about 18.2% barium sulfate, about 5.4% mica, about 3.1% calcium silicate, and about 12.4% friction dust. Friction dust in an example embodiment may be ground shell fragments. Example friction dust that may be used includes straight, brown, black or modified. Example rubber powders that may be used include nitrile rubber or recycled rubber powder. The example embodiment material does not include copper, or steel, or antimony.

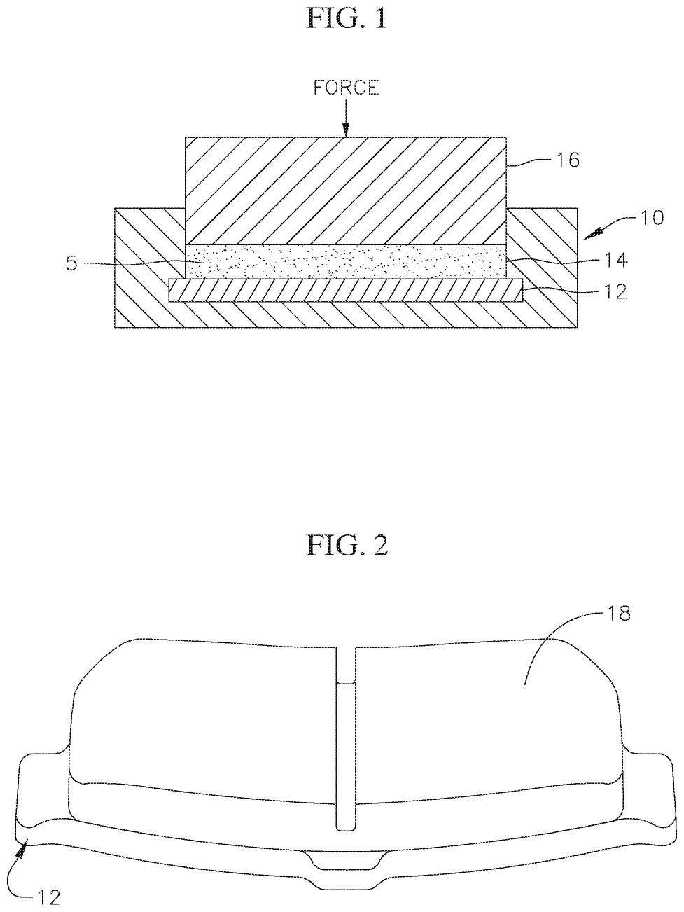

The components are mixed in a mixer, in an example embodiment, for 6-10 minutes to form a homogeneous mixture 5. The mixer may include a blade and/or separator so as to separate the fibers that are in the mixture. After mixing, the mixture is used to form brake pads. Two common methods of forming brake pads using the mixture include a positive molding method and flash molding. An apparatus and a method for positive molding for brake pads is disclosed in U.S. Pat. No. 5,911,925, the contents of which are fully incorporated herein by reference. The positive molding method, uses a mold 10 to form the brake pad, as for example shown schematically in FIG. 1. A backing plate 12 is fitted and retained in the mold 10. An adhesive may be placed on the backing plate. The mold defines a cavity 14 above the backing plate having a geometry of the desired pad. A predetermined volume (or weight) of the homogeneous mixture 5 is placed in the mold cavity 14 against the backing plate (and on the adhesive if an adhesive is used). A plunger 16 having a complementary geometric peripheral shape as the cavity is fitted into the cavity and sandwiches the mixture against the back plate. The mold is put in a press where the press applies a pressure in the range of 10-40 MPa on the plunger and thus on the homogeneous mixture against the backing plate, at a temperature of 300-340 F for 5-10 minutes. Typically the press incorporates a heating element for heating the element being pressed and the temperature of the press is controlled and monitored. Once pressed and heated, the homogeneous mixture solidifies and bonds to the backing plate forming a brake pad 18 attached to the backing plate 12. The formed brake pad with the backing plate is then further heated at a temperature of 430°-470° F. for 6-10 hours. This may be accomplished by placing the brake pad in a heated chamber such as an oven. The temperature is monitored in the chamber or oven space where the brake pad is placed. After heating is completed, the brake pad 18 with backing plate 12 may be machined to its final configuration, as for example shown in FIG. 2. After being formed the brake pad has the same amount of each of the compounds as they were in the homogeneous mixture.

Example embodiment brake pads formed as described herein have comparable friction performance in term of friction level (coefficient of friction), pad life, rotor life and noise compared to typical copper-containing and/or antimony-containing non-asbestos brake pads based on J2521, J2522 and J2707 SAE International testing protocols. Example embodiment brake pads were prepared with the following components: 12% by volume phenol aralkyl resin as the binder; 13.5% by volume lithium potassium titanate; 13.8% by volume zirconium silicate, iron oxide, magnesium oxide and aluminum oxide as the abrasives; 9.6% by volume synthetic graphite as the lubricant; 7.5% by volume aramid fibers; and 43.6% by volume fillers which included rubber powder, barium sulfate, calcium silicate, mica and friction dust.

Applicant's tested example embodiment brake pads for friction and wear resistance. The tested example embodiment brake pads had 12% by volume phenol aralkyl resin as the binder, 13.5% lithium potassium titanate, 43.6% fillers which were made up of 4.4% rubber, 18.2% barium sulfate, 5.4% mica, 3.1% calcium silicate, and 12.4% friction dust, 13.8% abrasives made up of 5.3% zirconium silicate, 2.6% iron oxide, 5.7% magnesium oxide, and 0.2% aluminum oxide, 9.6% synthetic graphite lubricant, and 7.5% aramid fiber. The friction tests were carried out based on the SAE International Brake Dynamometer Standard J2522 (Dynamometer Global Brake Effectiveness) Test procedure. These example embodiment brake pads generated equivalent or more breaking power when compared with Ford F-250 and Ford Crown Victoria original equipment supplier (OES) brake pads. Specifically these example embodiment brake pads generated an average coefficient of friction of 0.35. The coefficient of friction results are shown in Table 1 below.

TABLE 1
Coefficient of Friction

| | Example | |
|---|---|---|
| | Embodiment Brake | OES brake |
| Platform | Pads | pads |
| Ford F-250 | 0.41 | 0.40 |
| Ford Crown Victoria | 0.34 | 0.31 |

The wear resistance tests were carried out according to the SAE International Brake Dynamometer Standard J2707 (Wear Test Procedure on Inertia Dynamometer for Brake Friction Materials). The results of the testing are shown in Table 2 below.

TABLE 2
Wear-Thickness Loss

| | Example | |
|---|---|---|
| | Embodiment Brake | OES brake |
| Platform | Pads | pads |
| Ford F-250 | 3.76 mm | 4.48 mm |
| Ford Explorer | 1.31 mm | 3.35 mm |
| Ford Crown Victoria | 0.85 mm | 1.12 mm |

It was unexpected for these example embodiment materials to have such a combination of coefficient of friction and wear resistance. While better wear resistance was expected due to the use a higher volume of lubricant, the obtained coefficient of friction was unexpected in that it was expected to be much lower. It is known in the art that the addition of lubricant increases wear resistance but decreases coefficient of friction. Typically in brake pads, lubricants are limited to less than 5% by volume of the mixture forming the brake pads. In the example embodiment brake pads tested, the lubricant was 9.6% by volume of the mixture. Thus, a much lower coefficient of friction was expected, and one that was lower than the coefficient of friction of the comparable OES brake pads. As can be seen from the test results, the example embodiment brake pads provide for better wear resistance and greater coefficient of friction.

While the present disclosure has been described with respect to a limited number of embodiments, those skilled in the art, having benefit of this disclosure, will appreciate that other embodiments and modifications can be devised which do not materially depart from the scope of the invention as disclosed herein. All such embodiments and modifications are intended to be included within the scope of this disclosure as defined in the following claims.

1. A mixture having a volume for forming a brake pad comprising:
at least one binder in the range of 11% to 15% by volume of the mixture;
at least one type of fiber in the range of 3% to 8% by volume of the mixture;
at least one lubricant in the range 7% to 13% by volume of the mixture;
at least one type of fiber free potassium titanate or fiber free modified potassium titanate in the range of 11% to 16% by volume of the mixture;
at least two abrasives in the range of 13% to 17% by volume of the mixture; and
at least two fillers in the range of 31% to 55% by volume of the mixture.

2. The mixture of claim 1, wherein:
said at least one binder is in the range of 11% to 13% by volume of the mixture;
said at least one type of fiber is in the range of 6% to 8% by volume of the mixture;
said at least one lubricant is in the range of 8% to 10% by volume of the mixture;
said at least one type of fiber free potassium titanate or fiber free modified potassium titanate is in the range of 12% to 14% by volume of the mixture;
said at least two abrasives are in the range of 13% to 15% by volume of the mixture; and
said at least two fillers are in the range of 40% to 50% by volume of the mixture.

3. The mixture of claim 1, comprising:
12% by volume of the mixture of said at least one binder;
7.5% by volume of the mixture said at least one type of fiber;
9.6% by volume of the mixture said at least one lubricant;
13.5% by volume of the mixture of said at least one type of fiber-free potassium titanate;
13.8% by volume of the mixture of said at least two abrasives; and
43.6% by volume of the mixture of said at least two fillers.

4. The mixture of claim 3, wherein:
said at least one binder is a phenol aralkyl resin;
said at least one fiber is an aramid fiber;
said at least one lubricant is synthetic graphite;
said at least one type of fiber-free potassium titanate or fiber-free modified potassium titanate is lithium potassium titanate;
said at least two abrasives comprise,
zirconium silicate,
iron oxide,
magnesium oxide, and
aluminum oxide; and
said at least two fillers comprise,
rubber,
barium sulfate,
mica,
calcium silicate, and
friction dust.

5. The mixture of claim 4, wherein:
said zirconium silicate is 3% to 7% by volume of the mixture;
said iron oxide is 1% to 3% by volume of the mixture;
said magnesium oxide is 3% to 8% by volume of the mixture;
said aluminum oxide is 0.1% to 1.5% by volume of the mixture;
said rubber is 2% to 9% by volume of the mixture;
said barium sulfate is 16% to 21% by volume of the mixture;
said mica is 2% to 6% by volume of the mixture;
said calcium silicate is 1% to 4% by volume of the mixture; and
said friction dust 7% to 13% by volume of the mixture.

6. The mixture of claim 4, wherein:
said zirconium silicate is 5.3% by volume of the mixture;
said iron oxide is 2.6% by volume of the mixture;
said magnesium oxide is 5.7% by volume of the mixture;
said aluminum oxide is 0.2% by volume of the mixture;
said rubber is 4.4% by volume of the mixture;
said barium sulfate is 18.2% by volume;
said mica is 5.4% by volume of the mixture;
said calcium silicate is 3.1% by volume of the mixture; and
said friction dust 12.4% by volume of the mixture.

7. The mixture of claim 1, wherein:
said at least one type of binder is selected from the group of binders consisting essentially of unmodified and modified phenolic resins and combinations thereof;
said at least one type of fiber is selected from the group of fibers consisting essentially of aramid fibers, poly-acrylonitrile (PAN) fibers, cellulose fibers, and combinations thereof;
said at least one lubricant is selected from the group of lubricants consisting essentially of metal sulfides, metal alloys, graphite, petroleum coke, and combinations thereof;
said at least two abrasives are selected from the group of abrasives consisting essentially of aluminum oxides, magnesium oxides, iron oxides, sand, silicone carbides, silicon dioxides, zirconium oxides, zirconium silicates, and combinations thereof; and
said at least two fillers are selected from the group of fillers consisting essentially of barium sulfates, calcium carbonates, calcium silicates, friction dust, mica, rubber powders, and combinations thereof.

8. The mixture of claim 1, wherein:
said at least one type of binder is a phenol aralkyl resin;
said at least one type of fiber is an aramid fiber;
said at least one lubricant is synthetic graphite;
said at least two abrasives are selected from the group of abrasives consisting essentially of aluminum oxides, magnesium oxides, iron oxides, zirconium silicates, and combinations thereof; and
said at least two fillers are selected from the group of fillers consisting essentially of barium sulfates, calcium silicates, friction dust, mica, rubber powders, and combinations thereof.

9. The mixture of claim 8, wherein:
said at least one binder is in the range of 11% to 13% by volume of the mixture;
said at least one type of fiber is in the range of 6% to 8% by volume of the mixture;
said at least one solid lubricant is in the range of 8% to 10% by volume of the mixture;
said at least one type of fiber free potassium titanate or fiber free modified potassium titanate is in the range of 12% to 14% by volume of the mixture;
said at least two abrasives are in the range of 13% to 15% by volume of the mixture; and
said at least two fillers are in the range of 40% to 50% by volume of the mixture.

10. A method for forming a brake pad comprising:
creating the mixture recited in claim 1;
placing the mixture in a mold;
pressing the homogeneous mixture at a pressure in the range of 10 to 40 MPa and at a temperature in the range of 300 to 340 F for a period of 5 to 10 minutes forming a solidified mixture; and
heating the solidified mixture at a temperature of 430 to 470′F forming said brake pad.

11. The method of claim 10, further comprising placing a backing plate in said mold, and wherein placing the mixture comprises placing the mixture on said backing plate; and wherein said formed brake pad is bonded to said backing plate.

12. The method of claim 10, wherein creating said mixture comprising mixing:
said at least one binder is, in the range of 11% to 13% by volume of the mixture;
said at least one type of fiber is in the range of 6% to 8% by volume of the mixture;
said at least one solid lubricant is in the range of 8% to 10% by volume of the mixture;
said at least one type of fiber free potassium titanate or fiber free modified potassium titanate is in the range of 12% to 14% by volume of the mixture;
said at least two abrasives are in the range of 13% to 15% by volume of the mixture; and
said at least two fillers are in the range of 40% to 50% by volume of the mixture.

13. The method of claim 10, wherein:
said at least one type of binder is selected from the group of binders consisting essentially of unmodified and modified phenolic resins and combinations thereof;
said at least one type of fiber is selected from the group of fibers consisting essentially of aramid fibers, poly-acrylonitrile (PAN) fibers, cellulose fibers, and combinations thereof;
said at least one lubricant is selected from the group of lubricants consisting essentially of metal sulfides, metal alloys, graphite, petroleum coke, and combinations thereof;
said at least two abrasives are selected from the group of abrasives consisting essentially of aluminum oxides, magnesium oxides, iron oxides, sand, silicone carbides, silicon dioxides, zirconium oxides, zirconium silicates, and combinations thereof; and
said at least two fillers are selected from the group of fillers consisting essentially of barium sulfates, calcium carbonates, calcium silicates, friction dust, mica, rubber powders, and combinations thereof.

14. The method of claim 10, wherein creating said mixture comprises mixing:
12% by volume of the mixture of said at least one binder;
7.5% by volume of the mixture said at least one type of fiber;
9.6% by volume of the mixture said at least one lubricant;
13.5% by volume of the mixture of said at least one type of fiber-free potassium titanate;
13.8% by volume of the mixture of said at least two abrasives; and
43.6% by volume of the mixture of said at least two fillers.

15. A brake pad comprising:
at least one binder in the range of 11% to 15% by volume of the brake pad;
at least one type of fiber in the range of 3% to 8% by volume of the brake pad;
at least one lubricant in the range 7% to 13% by volume of the brake pad;
at least one type of fiber free potassium titanate or fiber free modified potassium titanate in the range of 11% to 16% by volume of the brake pad;
at least two abrasives in the range of 13% to 17% by volume of the brake pad; and
at least two fillers in the range of 31% to 55% by volume of the brake pad.

16. The brake pad of claim 15, wherein:
said at least one binder is in the range of 11% to 13% by volume of the brake pad;
said at least one type of fiber is in the range of 6% to 8% by volume of the brake pad;
said at least one lubricant is in the range of 8% to 10% by volume of the brake pad;
said at least one type of fiber free potassium titanate or fiber free modified potassium titanate is in the range of 12% to 14% by volume of the brake pad;
said at least two abrasives are in the range of 13% to 15% by volume of the brake pad; and
said at least two fillers are in the range of 40% to 50% by volume of the brake pad.

17. The brake pad of claim 15, comprising:
12% by volume of the brake pad of said at least one binder;
7.5% by, volume of the brake pad said at least one type of fiber;
9.6% by volume of the brake pad said at least one lubricant;
13.5% by volume of the brake pad of said at least one type of fiber-free potassium titanate;
13.8% by volume of the brake pad of said at least two abrasives; and
43.6% by volume of the brake pad of said at least two fillers.

18. The brake pad of claim 17, wherein:
said at least one binder is a phenol aralkyl resin;
said at least one fiber is an aramid fiber;
said at least one lubricant is synthetic graphite;
said at least one type of fiber-free potassium titanate or fiber-free modified potassium titanate is lithium potassium titanate;
said at least two abrasives comprise,
zirconium silicate,
iron oxide,
magnesium oxide, and
aluminum oxide; and
said at least two fillers comprise,
rubber,
barium sulfate,
mica,
calcium silicate, and
friction dust.

19. The brake pad of claim 18, wherein:
said zirconium silicate is 3% to 7% by volume of the brake pad;
said iron oxide is 1% to 3% by volume of the brake pad;
said magnesium oxide is 3% to 8% by volume of the brake pad;
said aluminum oxide is 0.1% to 1.5% by volume of the brake pad;
said rubber is 2% to 9% by volume of the brake pad;
said barium sulfate is 16% to 21% by volume of the brake pad;
said mica is 2% to 6% by volume of the brake pad;
said calcium silicate is 1% to 4% by volume of the brake pad; and
said friction dust 7% to 13% by volume of the brake pad.

20. The brake pad of claim 18, wherein:
said zirconium silicate is 5.3% by volume of the brake pad;
said iron oxide is 2.6% by volume of the brake pad;
said magnesium oxide is 5.7% by volume of the brake pad;
said aluminum oxide is 0.2% by volume of the brake pad;
said rubber is 4.4% by volume of the brake pad;
said barium sulfate is 18.2% by volume of the brake pad;
said mica is 5.4% by volume of the brake pad;
said calcium silicate is 3.1% by volume of the brake pad; and
said friction dust 12.4% by volume of the brake pad.

21. The brake pad of claim 15, wherein:
said at least one type of binder is selected from the group of binders consisting essentially of unmodified and modified phenolic resins and combinations thereof;
said at least one type of fiber is selected from the group of fibers consisting essentially of aramid fibers, poly-acrylonitrile (PAN) fibers, cellulose fibers, and combinations thereof;
said at least one lubricant is selected from the group of lubricants consisting essentially of metal sulfides, metal alloys, graphite, petroleum coke, and combinations thereof;
said at least two abrasives are selected from the group of abrasives consisting essentially of aluminum oxides, magnesium oxides, iron oxides, sand, silicone carbides, silicon dioxides, zirconium oxides, zirconium silicates, and combinations thereof; and
said at least two fillers are selected from the group of fillers consisting essentially of barium sulfates, calcium carbonates, calcium silicates, friction dust, mica, rubber powders, and combinations thereof.

22. The brake pad of claim 15, wherein:
said at least one type of binder is a phenol aralkyl resin;
said at least one type of fiber is an aramid fiber;
said at least one lubricant is synthetic graphite;
said at least two abrasives are selected from the group of abrasives consisting essentially of aluminum oxides, magnesium oxides, iron oxides, zirconium silicates, and combinations thereof; and
said at least two fillers are selected from the group of fillers consisting essentially of barium sulfates, calcium silicates, friction dust, mica, rubber powders, and combinations thereof.

23. The brake pad of claim 22, wherein:
said at least one binder is in the range of 11% to 13% by volume of the brake pad;
said at least one type of fiber is in the range of 6% to 8% by volume of the brake pad;
said at least one solid lubricant is in the range of 8% to 10% by volume of the brake pad;
said at least one type of fiber free potassium titanate or fiber free modified potassium titanate is in the range of 12% to 14% by volume of the brake pad;
said at least two abrasives are in the range of 13% to 15% by volume of the brake pad; and
said at least two fillers are in the range of 40% to 50% by volume of the brake pad.

24. The mixture of claim 1, wherein said mixture does not include copper.

25. The brake pad of claim 15, wherein said brake pad does not include copper.
